(19) United States
(12) Patent Application Publication
(10) Pub. No.: US 2012/0146866 A1
(43) Pub. Date: Jun. 14, 2012

(54) WIRELESS COMMUNICATION ANTENNA DEVICE

(75) Inventors: Chang-Hsiu HUANG, Hsinchu (TW); Chung-Min LAI, Hsinchu (TW); I-Ching LAN, Hsinchu (TW)

(73) Assignee: WISTRON NEWEB CORPORATION, Hsinchu (TW)

(21) Appl. No.: 12/979,385

(22) Filed: Dec. 28, 2010

(30) Foreign Application Priority Data
Dec. 14, 2010 (TW) 099143787

(51) Int. Cl. H01Q 13/02; H01Q 15/24

(52) U.S. Cl. 343/756; 343/786

(57) ABSTRACT

A wireless communication antenna device includes a horn antenna and a waveguide. The horn antenna for transmitting or receiving a polarized wireless electromagnetic wave having a first electric field component and a second electric field component, the first electric field component and the second electric field component being orthogonal with each other. The waveguide connected to the horn antenna, for propagating the polarized wireless electromagnetic wave. Wherein a first opening of the waveguide includes a side corresponding to the first electric field component and another side corresponding to the second electric field component, and a length of the side corresponding to the first electric field component is different from a length of the side corresponding to the second electric field component, such that the first electric field component and the second electric field component have a phase difference therebetween when the polarized wireless electromagnetic wave is propagated in the waveguide.

### RELATED APPLICATIONS

This application claims priority to Taiwan Application Serial Number 099143787, filed Dec. 14, 2010, which is herein incorporated by reference.

### BACKGROUND

1. Technical Field

The present invention relates generally to a communication device, and more particularly to a wireless communication antenna device.

2. Description of Related Art

With a rapid development of electronic technology, wireless communication has become a main medium for signal transmission. There are different types of antennas utilized in wireless communication systems, for example, dipole antenna, monopole antenna, microstrip antenna, horn antenna, dish antenna, etc. The dish antenna has the advantages of high directivity and high gain, so the dish antenna has been widely used in satellite communication and terrestrial microwave communication systems.

In view of the radiation efficiency of the dish antenna system, the horn antenna (e.g. elliptical horn antenna) is therefore a better type of the feed antenna in the dish antenna system.

In practice, the dish antenna system further includes a polarizer connected with the horn antenna used as the feed antenna. The polarizer can be a conventional 90-degree polarizer, in which the 90-degree polarizer is configured for dividing a linearly polarized wireless electromagnetic wave into two components having a 90-degree phase difference therebetween and being orthogonal with each other, and then a circularly polarized wireless electromagnetic wave is formed. That is, the original linearly polarized wireless electromagnetic wave can be translated to the circularly polarized wireless electromagnetic wave by the 90-degree polarizer. Similarly, the 90-degree polarizer can translate the polarized wireless electromagnetic wave from circular polarization to linear polarization as well.

Besides, when the horn antenna, which has a non-equilateral transverse opening, transmits or receives the circularly polarized wireless electromagnetic wave, a vertical electric field component and a horizontal electric field component being orthogonal with each other separately have different phase velocities, such that the vertical electric field component and the horizontal electric field component have a phase difference therebetween. Thus, the connection and operation of the 90-degree polarizer with the horn antenna will not yield an optimum propagation performance of the electromagnetic wave and translation performance between linear polarization and circular polarization.

Therefore, there is a need providing a wireless communication antenna device for optimizing the propagation performance and the translation performance of the polarized wireless electromagnetic wave.

### SUMMARY

The present invention provides a waveguide having a transverse opening with non-equilateral lengths and/or non-symmetric axes, for compensating a phase difference between a vertical electrical field component and a horizontal electrical field component of a polarized wireless electromagnetic wave propagated within a horn antenna.

One aspect of the present invention provides a wireless communication antenna device including a horn antenna and a waveguide. The horn antenna is used for transmitting or receiving a polarized wireless electromagnetic wave having a first electric field component and a second electric field component, and the first electric field component and the second electric field component are orthogonal with each other. The waveguide is connected to the horn antenna, for propagating the polarized wireless electromagnetic wave, wherein a first opening of the waveguide includes a side corresponding to the first electric field component and another side corresponding to the second electric field component, and a length of the side corresponding to the first electric field component is different from a length of the side corresponding to the second electric field component, such that the first electric field component and the second electric field component have a phase difference therebetween when the polarized wireless electromagnetic wave is propagated in the waveguide.

According to one embodiment of the present invention, the length of the side corresponding to the first electric field component is a first length, and the length of the side corresponding to the second electric field component is a second length, and the first length and the second length are increased or decreased along the direction of propagation of the polarized wireless electromagnetic wave.

According to another embodiment of the present invention, the waveguide has a first lengthwise face and a second lengthwise face connected adjacently to the first lengthwise face. A first included angle is formed between the first lengthwise face and the direction of propagation of the polarized wireless electromagnetic wave, and a second included angle is formed between the second lengthwise face and the direction of propagation of the polarized wireless electromagnetic wave.

According to yet another embodiment of the present invention, a second opening of the waveguide is the same as or different from the first opening of the waveguide.

According to a further embodiment of the present invention, the wireless communication antenna device further includes a polarizer connected with the waveguide, for providing a translation between linear polarization and circular polarization of the polarized wireless electromagnetic wave.

Another aspect of the present invention provides a wireless communication antenna device including a horn antenna and a waveguide. The horn antenna is used for transmitting or receiving a polarized wireless electromagnetic wave having a first electric field component and a second electric field component, and the first electric field component and the second electric field component are orthogonal with each other. The waveguide is connected to the horn antenna, for propagating the polarized wireless electromagnetic wave. A first opening of the waveguide is elliptical, the first opening includes a major axis corresponding to the first electric field component and a minor axis corresponding to the second electric field component, and the major axis is different from the minor axis, such that the first electric field component and the second electric field component have a phase difference therebetween when the wireless polarized wave is propagated in the waveguide.

According to one embodiment of the present invention, the major axis and the minor axis are increased or decreased along the direction of propagation of the polarized wireless electromagnetic wave.

According to another embodiment of the present invention, the waveguide has a major lengthwise face and a minor lengthwise face, a first included angle is formed between the major lengthwise face and the direction of propagation of the polarized wireless electromagnetic wave, and a second included angle is formed between the minor lengthwise face and the direction of propagation of the polarized wireless electromagnetic wave.

According to yet another embodiment of the present invention, a second opening of the waveguide is the same as or different from the first opening of the waveguide.

According to a further embodiment of the present invention, the wireless communication antenna device further includes a polarizer connected with the waveguide, for providing a translation between linear polarization and circular polarization of the polarized wireless electromagnetic wave.

### BRIEF DESCRIPTION OF THE DRAWINGS

The invention can be more fully understood by reading the following detailed description of the embodiments, with reference made to the accompanying drawings as follows:

FIG. 1 shows a wireless communication antenna device;

FIG. 2A is a three-dimensional diagram of the waveguide according to one embodiment of the present invention;

FIG. 2B is a diagram of a lengthwise face of the waveguide shown in FIG. 2A according to one embodiment of the present invention;

FIG. 2C is a diagram of another lengthwise face of the waveguide shown in FIG. 2A according to one embodiment of the present invention;

FIG. 3 is a three-dimensional diagram of the waveguide according to another embodiment of the present invention;

FIG. 4A is a three-dimensional diagram of the waveguide according to yet another embodiment of the present invention;

FIG. 4B is a diagram of a lengthwise face of the waveguide shown in FIG. 4A according to yet another embodiment of the present invention;

FIG. 4C is a diagram of another lengthwise face of the waveguide shown in FIG. 4A according to yet another embodiment of the present invention; and

FIG. 5 is a three-dimensional diagram of the waveguide according to still another embodiment of the present invention.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

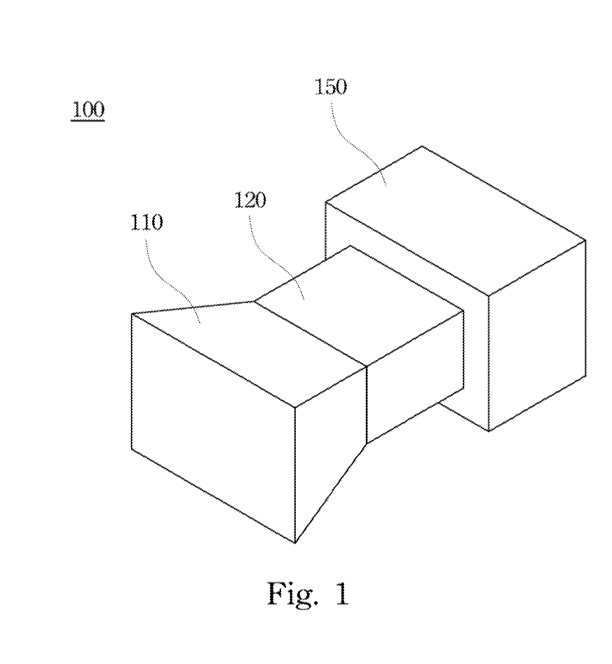

According to one embodiment of the present invention, a wireless communication antenna device 100 is shown in FIG. 1. The wireless communication antenna device 100 includes a horn antenna 110, a waveguide 120 and a polarizer 150, in which the horn antenna 110 is used for transmitting or receiving a polarized wireless electromagnetic wave having a first electric field component and a second electric field component, and the first electric field component and the second electric field component are orthogonal with each other. The waveguide 120 is disposed between the horn antenna 110 and the polarizer 150, and the waveguide 120 is connected with the horn antenna 110 and the polarizer 150. The polarizer 150 is used for providing a good translation between linear polarization and circular polarization of the polarized wireless electromagnetic wave. For example, the polarizer 150 is used for translating the polarized wireless electromagnetic wave from having linear polarization to having circular polarization, or translating the polarized wireless electromagnetic wave from having circular polarization to having linear polarization. When the polarized wireless electromagnetic wave is propagated in the waveguide 120 having a transverse opening with non-equilateral lengths and/or non-symmetric axes, a phase difference is formed between the first electric field component and the second electric field component, for compensating the phase difference of the polarized wireless electromagnetic wave propagated in the horn antenna 110, such that optimum phase characteristics and the translation performance between linear polarization and circular polarization of the polarized wireless electromagnetic wave propagated in the wireless communication device 100 can be achieved. The horn antenna 110 is not intended to be limited to a rectangular horn antenna and/or an elliptical horn antenna, and the horn antenna 110 illustrated above is not intended to be limited to a feed antenna in the dish antenna system. The polarizer 150 is not intended to be limited as a 90-degree polarizer. The diagram in the present embodiment is used for illustrating a connection relationship between the horn antenna 110, the waveguide 120 and the polarizer 150, and the structures and the shapes of the horn antenna 110, the waveguide 120 and the polarizer 150 are not intended to be limited.

A brief principle of the polarized wireless electromagnetic wave propagated in the waveguide 120 will be illustrated below. The electromagnetic wave propagated in the waveguide 120 with different transverse dimensions travels at different phase velocities. If the transverse dimensions of the waveguide 120 are, non-equilateral, the fundamental modes of the electromagnetic wave in the waveguide 120, therefore, have different phase velocities. For example, the phase velocity of TEmn mode in a rectangular waveguide is ω/β, where ω is the angular frequency, β=\sqrt{k²−k²_{c}} is the propagation constant, k is wave number, k_{c}=\sqrt{(mπ/a)²+(nπ/b)²} is the cutoff wave number, m and n are integers greater than or equal to zero but not concurrently equal to zero, and a and b are inner dimensions of the waveguide 120. A rectangular waveguide 120 with inner dimensions a and b supports fundamental modes. If a>b, these fundamental modes are TE₀₁ mode and TE₁₀ mode, and both of two propagation modes are orthogonal with each other, and they have respective phase velocities different from each other. If in the beginning TE₀₁ mode and TE₁₀ mode have a phase difference φ₀, after these two modes travel a certain distance along the waveguide 120, they experience different amounts of phase change and their phase difference becomes φ₀+Δφ₁, where Δφ₁ depends on the distance they travel. Therefore, by controlling the length of the waveguide 120, arbitrary phase difference between two orthogonal propagation modes of the electromagnetic wave can be generated. Thus, a first electric field component and a second electric field component of the polarized wireless electromagnetic wave, respectively corresponding to the two orthogonal propagation modes mentioned above, are used for illustration in the embodiments of the present invention.

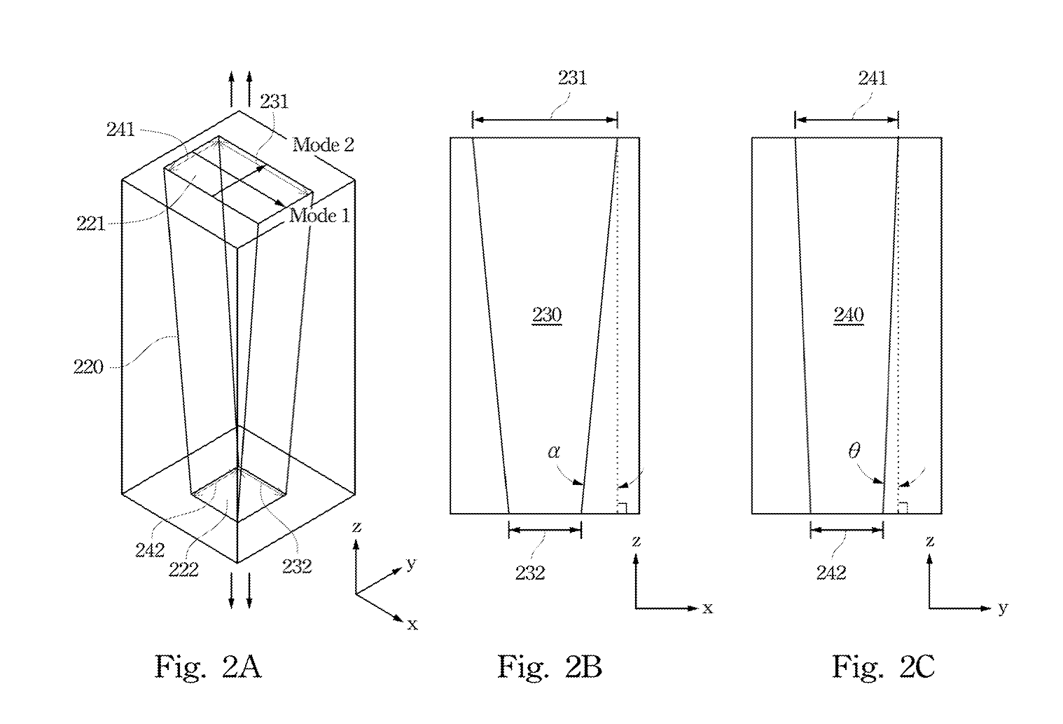

FIG. 2A is a three-dimensional diagram of the waveguide according to one embodiment of the present invention. A rectangular waveguide 220 is used for convenient illustration in the present embodiment, the first electric field component of the polarized wireless electromagnetic wave corresponds to the TE₀₁ mode (Mode 1) and the second electric field component of the polarized wireless electromagnetic wave corresponds to the TE₁₀ mode (Mode 2), and the propagation direction of the polarized wireless electromagnetic wave is represented by direction of the Z-axis, but the shape of the transverse opening of the waveguide 220 and the propagation direction of the polarized wireless electromagnetic wave are not intended to be limited.

In the embodiment, the waveguide 220 has a first opening 221, and the polarized wireless electromagnetic wave propagated in the waveguide 220 has the first electric field component and the second electric field component, in which the first electric field component and the second electric field component are orthogonal with each other. The first opening 221 of the waveguide 220 includes two sides respectively corresponding to the first and second electric field component, and the two sides respectively corresponding to the first and second electric field component have a first length 231 and a second length 241, respectively, wherein the first length 231 is different from the second length 241, such that the first electric field component and the second electric field component have a phase difference therebetween when the polarized wireless electromagnetic wave is propagated in the waveguide 220. In the embodiment of the present invention, although the first length 231 of the first opening 221 of the waveguide 220 corresponds to (e.g. in parallel to) the first electric field component, the mode characteristic of the first electric field component is controlled by the second length 241. Similarly, the second length 241 of the first opening 221 of the waveguide 220 corresponds to (e.g. in parallel to) the second electric field component, but the mode characteristic of the second electric field component is controlled by the first length 231. The corresponding and the controlling relationships between the lengths of the transverse opening of the waveguide 220 and the mode characteristics are illustrated above, and these features can be applied throughout the embodiments.

In another embodiment of the present invention, the first length 231 and the second length 241 are increased or decreased along the Z-axis (the direction of propagation of the polarized wireless electromagnetic wave). Specifically, the first length 231 of the first opening 221 of the waveguide 220 can be increased or decreased along the −Z direction, and the second length 241 of the first opening 221 of the waveguide 220 can be increased or decreased along the −Z direction, such that the transverse opening area of the waveguide 220 can be increased or decreased along the −Z direction.

For example, the waveguide 220 has a second opening 222 opposite to the first opening 221, and the second opening 222 has adjacently connected two sides having a length 232 and a length 242, respectively. The first length 231 of the first opening 221 can be decreased along the −Z direction, such that the first length 231 of the first opening 221 is greater than the length 232 of the second opening 222, while the second length 241 of the first opening 221 can be decreased along the −Z direction, such that the second length 241 of the first opening 221 is greater than the length 242 of the second opening 222.

FIG. 2B and FIG. 2C are diagrams of different lengthwise faces of the waveguide shown in FIG. 2A. In yet another embodiment of the present invention, the waveguide 220 has a first lengthwise face 230 and a second lengthwise face 240 connected adjacently to the first lengthwise face 230. A first included angle α is formed between the first lengthwise face 230 and the Z-axis, and a second included angle θ is formed between the second lengthwise face 240 and the Z-axis, wherein the first included angle α and the second included angle θ can be the same or different. A ratio of the adjacent lengths of the first opening 221 of the waveguide 220 is a ratio of the first length 231 over the second length 241. If the first included angle α is equal to the second included angle θ, then the ratio of the adjacent lengths of the first opening 221 of the waveguide 220 will maintain the same along the −Z direction. If the first included angle α is not equal to the second included angle θ, then the ratio of the adjacent lengths of the first opening 221 of the waveguide 220 will not maintain the same along the −Z direction.

In a further embodiment of the present invention, the second opening 222 of the waveguide 220 is different from the first opening 221 of the waveguide 220. For example, when the second opening 222 is different from the first opening 221 of the waveguide 220, that means the transverse opening area of the waveguide 220 will be changed along the Z-axis; that is, the first included angle α is different from the second included angle θ. The shapes of two transverse openings of the waveguide 220 can be demonstrated as follows: the first opening 221 is rectangular and the second opening 222 is square, or the first opening 221 is rectangular and the second opening 222 is another rectangular having different dimensions from the first opening 221. Therefore, the phase velocity of the first electric field component is different from the phase velocity of the second electric field component, when the first electric field component and the second electric field component are propagated in the waveguide 220, and thus the phase difference is formed.

The relationships of the first included angle α and the second included angle θ can be applied to the entire body of the waveguide 220 in the illustration above, and it is not intended to limit the pervious relationships at the first opening 221 or at the second opening 222 without departing from the spirit and scope of the present invention.

On the other hand, a change of the transverse area traveling along the Z-axis between the first opening 221 and the second opening 222 of the waveguide 220 has to meet the relationship between the adjacent lengths of the openings of the waveguide 220 and the cutoff frequency of the propagation modes, because the waveguide 220 having the transverse opening with particular sides and lengths thereof guides the electromagnetic wave with a particular range of frequency and has a particular cutoff frequency. The propagation mode of the electromagnetic wave can be propagated in the waveguide 220 when the propagated frequency is greater than the cutoff frequency. Therefore, the length of the waveguide 220, which ranges from the first length 231 and the second length 241 of the first opening 221 of the waveguide 220 to the first length 232 and the second length 242 of the second opening 222 of the waveguide 220, has to be limited, such that the lengths of the transverse opening of the waveguide 220 have to be greater than the lengths corresponding to the cutoff frequency to avoid that the electromagnetic wave cannot be guided within the waveguide 220.

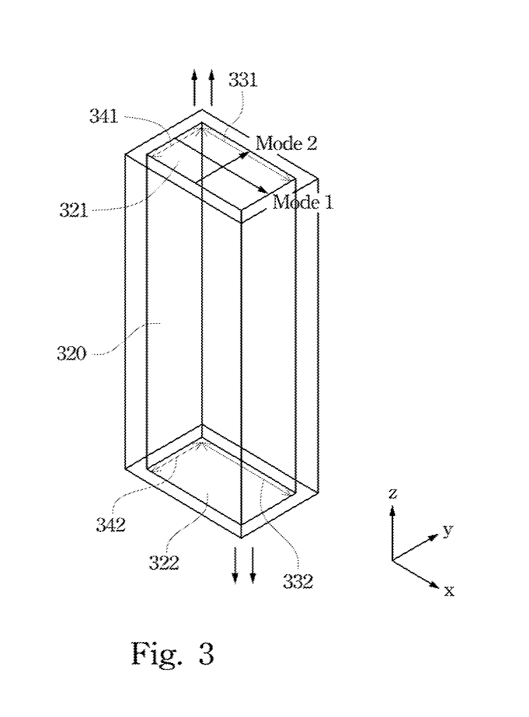

FIG. 3 is a three-dimensional diagram of the waveguide according to yet a further embodiment of the present invention. Compared to the waveguide 220 in FIG. 2A, the waveguide 320 similarly has a first opening 321 and a second opening 322. A length of the side of the first opening 321 corresponding to the first electric field component is a first length 331, and another length of the side of the first opening 321 corresponding to the second electric field component is a second length 341, wherein the first length 331 is different from the second length 341. Moreover, a length of the side of the second opening 322 corresponding to the first electric field component is the first length 332, and another length of the side of the first opening 321 corresponding to the second electric field component is the second length 342, wherein the first length 332 is different from the second length 342. Because the first opening 321 is the same as the second opening 322 of the waveguide 320, the transverse opening area and the adjacent lengths of the transverse opening of the waveguide 320 will not be changed along the Z-axis, thus the first included angle α and the second included angle θ corresponding to FIG. 2B and FIG. 2C are zero.

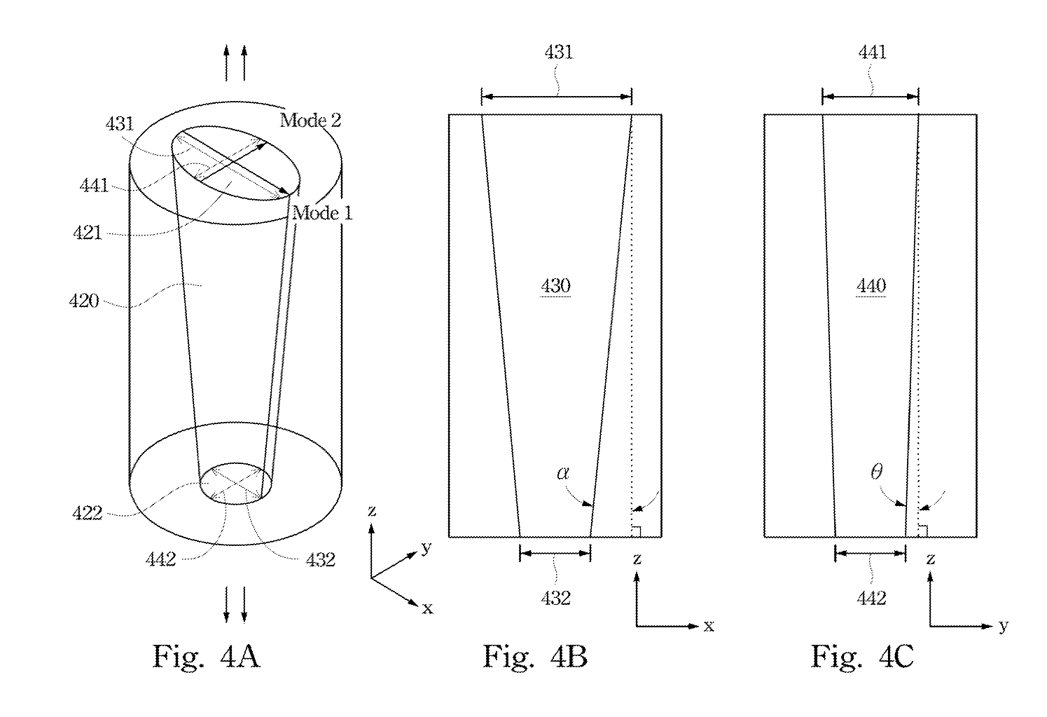

FIG. 4A is a three-dimensional diagram of the waveguide according to one embodiment of the present invention. An elliptical waveguide 420 is used for convenient illustration in the present embodiment, the first electric field component of the polarized wireless electromagnetic wave corresponds to the Mode 1 and the second electric field component of the polarized wireless electromagnetic wave corresponds to the Mode 2, and the propagation direction of the polarized wireless electromagnetic wave is represented by direction of the Z-axis, but the shape of the transverse opening of the waveguide 420 and the propagation direction of the polarized wireless electromagnetic wave are not intended to be limited.

In the embodiment, the waveguide 420 has a first opening 421, and the polarized wireless electromagnetic wave propagated in the waveguide 420 has the first electric field component and the second electric field component, and the first electric field component and the second electric field component are orthogonal with each other. The first opening 421 of the waveguide 420 includes a major axis 431 corresponding to the first electric field component and a minor axis 441 corresponding to the second electric field component, wherein the major axis 431 is different from the minor axis 441, such that the first electric field component and the second electric field component have a phase difference therebetween when the polarized wireless electromagnetic wave is propagated in the waveguide 420. In the embodiment of the present invention, although the major axis 431 of the first opening 421 of the waveguide 420 corresponds to (e.g. in parallel to) the first electric field component, the mode characteristic of the first electric field component is controlled by the minor axis 441. Similarly, the minor axis 441 of the first opening 421 of the waveguide 420 corresponds to (e.g. in parallel to) the second electric field component, but the mode characteristic of the second electric field component is controlled by the major axis 431. The corresponding and the controlling relationships between the axes of the transverse opening of the waveguide 420 and the mode characteristics are illustrated above, and these features can be applied throughout the embodiments.

In another embodiment of the present invention, the major axis 431 and the minor axis 441 are increased or decreased along the Z-axis (the direction of propagation of the polarized wireless electromagnetic wave). Specifically, the major axis 431 of the first opening 421 of the waveguide 420 can be increased or decreased along the −Z direction, and the minor axis 441 of the first opening 421 of the waveguide 420 can be increased or decreased along the −Z direction, such that the transverse opening area of the waveguide 420 can be increased or decreased along the −Z direction.

For example, the waveguide 420 has a second opening 422 opposite to the first opening 421, and the second opening 422 has a major axis 432 and a minor axis 442, in which the major axis 432 and the minor axis 442 are orthogonal with each other. The major axis 431 of the first opening 421 can be decreased along the −Z direction, such that the major axis 431 of the first opening 421 is greater than the major axis 432 of the second opening 422, while the minor axis 441 of the first opening 421 can be decreased along the −Z direction, such that the minor axis 441 of the first opening 421 is greater than the minor axis 442 of the second opening 422.

FIG. 4B and FIG. 4C are diagrams of different lengthwise faces of the waveguide shown in FIG. 4A. In yet another embodiment of the present invention, the waveguide 420 has a major lengthwise face 430 and a minor lengthwise face 440, in which the major lengthwise face 430 and the minor lengthwise face 440 are orthogonal with each other. A first included angle α is formed between the major lengthwise face 430 and the Z-axis, and a second included angle θ is formed between the minor lengthwise face 440 and the Z-axis, wherein the first included angle α and the second included angle θ can be the same or different. A ratio of the orthogonal axes of the first opening 421 of the waveguide 420 is a ratio of the major axis 431 over the minor axis 441. If the first included angle α is equal to the second included angle θ, then the ratio of the orthogonal axes of the first opening 421 of the waveguide 420 will maintain the same along the −Z direction. If the first included angle α is not equal to the second included angle θ, then the ratio of the orthogonal axes of the first opening 421 of the waveguide 420 will not maintain the same ratio along the −Z direction.

In a further embodiment of the present invention, the second opening 422 of the waveguide 420 is different from the first opening 421 of the waveguide 420. For example, when the second opening 422 is different from the first opening 421 of the waveguide 420, that means the transverse opening area of the waveguide 420 will be changed along the Z-axis; that is, the first included angle α is different from the second included angle θ. The shapes of two transverse openings of the waveguide 420 can be demonstrated as follows: the first opening 421 is elliptical and the second opening 422 is circular, or the first opening 421 is elliptical and the second opening 422 is elliptical and having different dimensions from the first opening 421. Therefore, the phase velocity of the first electric field component is different from the phase velocity of the second electric field component, when the first electric field component and the second electric field component are propagated in the waveguide 420, and thus the phase difference is formed.

The relationships of the first included angle α and the second included angle θ can be applied to the entire body of the waveguide 420 in the illustration above, and it is not intended to limit the pervious relationships at the first opening 421 or at the second opening 422 without departing from the spirit and scope of the present invention.

On the other hand, a change of the transverse area traveling along the Z-axis between the first opening 421 and the second opening 422 of the waveguide 420 has to meet the relationship between the orthogonal axes of the openings of the waveguide 420 and the cutoff frequency of the propagation modes, because the waveguide 420 having the transverse opening with particular axes thereof guides the electromagnetic wave with a particular range of frequency and has a particular cutoff frequency. The propagation mode of the electromagnetic wave can be propagated in the waveguide 420 when the propagated frequency is greater than the cutoff frequency. Therefore, the axis of the waveguide 420, which ranges from the major axis 431 and the minor axis 441 of the first opening 421 of the waveguide 420 to the major axis 432 and the minor axis 442 of the second opening 422 of the waveguide 420, has to be limited, such that the axes of the transverse opening of the waveguide 420 have to be greater than the axes corresponding to the cutoff frequency to avoid that the electromagnetic wave cannot be guided within the waveguide 420.

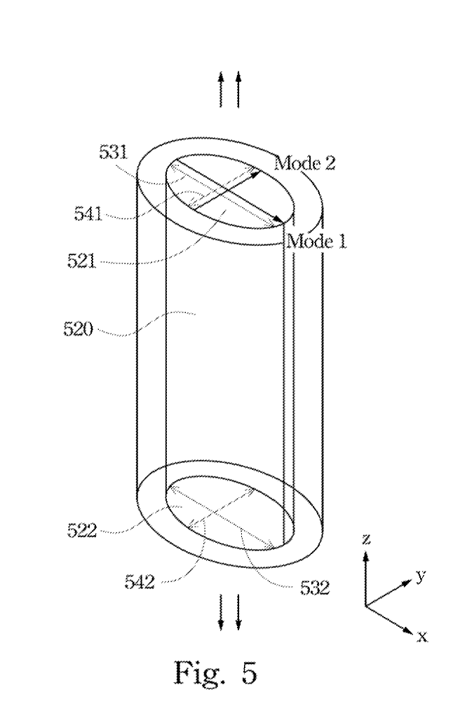

FIG. 5 is a three-dimensional diagram of the waveguide according to yet a further embodiment of the present invention. Compared to the waveguide 420 in FIG. 4A, the waveguide 520 similarly has a first opening 521 and a second opening 522. A major axis 531 of the first opening 521 corresponds to the first electric field component, and a minor axis 541 of the first opening 521 corresponds to the second electric field component, wherein the major axis 531 is different from the minor axis 541. Moreover, a major axis 532 of the second opening 522 corresponds to the first electric field component, and a minor axis 542 of the second opening 522 corresponds to the second electric field component, wherein the major axis 532 is different from the minor axis 542. Because the first opening 521 is the same as the second opening 522 of the waveguide 520, the transverse opening area and the orthogonal axes of the transverse opening of the waveguide 520 will not be changed along the Z-axis, thus the first included angle α and the second included angle θ corresponding to FIG. 4B and FIG. 4C are zero.

Compared to the prior art, the present invention provides a waveguide having a transverse opening with non-equilateral lengths and/or a non-symmetry axes, such that the first electric field component and the second electric field component which are orthogonal with each other have a phase difference therebetween when the polarized wireless electromagnetic wave is propagated in the waveguide, for compensating the phase difference of the polarized wireless electromagnetic wave propagated in the horn antenna, thus an arbitrary phase difference can be created by controlling the length of the waveguide body for different requirements, such that the phase characteristics of the propagation of the polarized wireless electromagnetic wave and the translation performance between the linear polarization and the circular polarization can be improved.

Although the present invention has been described with reference to a preferred embodiment thereof, this embodiment is not intended to limit the present invention. It will be apparent to those skilled in the art that various modifications and variations can be made without departing from the scope or spirit of the present invention. Therefore, the scope of the present invention shall be defined by the appended claims.

What is claimed is:

1. A wireless communication antenna device, comprising:
a horn antenna for transmitting or receiving a polarized wireless electromagnetic wave having a first electric field component and a second electric field component, the first electric field component and the second electric field component being orthogonal with each other; and
a waveguide connected to the horn antenna, for propagating the polarized wireless electromagnetic wave, wherein a first opening of the waveguide comprises a side corresponding to the first electric field component and another side corresponding to the second electric field component, and a length of the side corresponding to the first electric field component is different from a length of the side corresponding to the second electric field component, such that the first electric field component and the second electric field component have a phase difference therebetween when the polarized wireless electromagnetic wave is propagated in the waveguide.

2. The wireless communication antenna device of claim 1, wherein the length of the side corresponding to the first electric field component is a first length, and the length of the side corresponding to the second electric field component is a second length, and the first length and the second length are increased or decreased along the direction of propagation of the polarized wireless electromagnetic wave.

3. The wireless communication antenna device of claim 2, wherein the waveguide has a first lengthwise face and a second lengthwise face connected adjacently to the first lengthwise face, a first included angle is formed between the first lengthwise face and the direction of propagation of the polarized wireless electromagnetic wave, and a second included angle is formed between the second lengthwise face and the direction of propagation of the polarized wireless electromagnetic wave.

4. The wireless communication antenna device of claim 1, wherein a second opening of the waveguide is the same as or different from the first opening of the waveguide.

5. The wireless communication antenna device of claim 1, further comprising a polarizer connected with the waveguide, for providing a translation between linear polarization and circular polarization of the polarized wireless electromagnetic wave.

6. A wireless communication antenna device, comprising:
a horn antenna for transmitting or receiving a polarized wireless electromagnetic wave having a first electric field component and a second electric field component, the first electric field component and the second electric field component being orthogonal with each other; and
a waveguide connected to the horn antenna, for propagating the polarized wireless electromagnetic wave, wherein a first opening of the waveguide is elliptical, the first opening comprises a major axis corresponding to the first electric field component and a minor axis corresponding to the second electric field component, and the major axis is different from the minor axis, such that the first electric field component and the second electric field component have a phase difference therebetween when the polarized wireless electromagnetic wave is propagated in the waveguide.

7. The wireless communication antenna device of claim 6, wherein the major axis and the minor axis are increased or decreased along the direction of propagation of the polarized wireless electromagnetic wave.

8. The wireless communication antenna device of claim 7, wherein the waveguide has a major lengthwise face and a minor lengthwise face, a first included angle is formed between the major lengthwise face and the direction of propagation of the polarized wireless electromagnetic wave, and a second included angle is formed between the minor lengthwise face and the direction of propagation of the polarized wireless electromagnetic wave.

9. The wireless communication antenna device of claim 6, wherein a second opening of the waveguide is the same as or different from the first opening of the waveguide.

10. The wireless communication antenna device of claim 6, further comprising a polarizer connected with the waveguide, for providing a translation between linear polarization and circular polarization of the polarized wireless electromagnetic wave.
